(19) United States
(12) Patent Application Publication
(10) Pub. No.: US 2021/0269074 A1
(43) Pub. Date: Sep. 2, 2021

(54) WARNING DEVICE FOR A RAIL VEHICLE

(71) Applicant: SIEMENS MOBILITY GMBH, MUENCHEN (DE)

(72) Inventors: CHRISTIAN STROESSNER, GROSSENSEEBACH (DE); GEORG LOHNEIS, EBENSFELD (DE)

(21) Appl. No.: 17/256,297

(22) PCT Filed: Jun. 18, 2019
(86) PCT No.: PCT/EP2019/066019

§ 371 Date: Dec. 28, 2020

(30) Foreign Application Priority Data
Jun. 26, 2018 (DE) 10 2018 210 408.5

(51) Int. Cl. B61L 15/00; G06F 3/14; H04L 29/08; B61L 27/00; B61K 9/00

(52) U.S. Cl. CPC B61L 15/009; G06F 3/14; H04L 67/12; B61L 27/0005; B61L 15/0081; B61L 27/0094; B61L 15/0027; B61L 15/0054; B61K 9/00

(57) ABSTRACT

A warning device and system for a rail vehicle includes at least the following components: an error detection apparatus, designed to detect at least one error condition of the rail vehicle, an image memory containing a number of images which indicate an actual condition of a rail vehicle, a first selection unit for selecting at least one of the images from the image memory in accordance with a detected error condition of the rail vehicle, at least one user interface with at least one display unit, a display control unit for controlling the display unit such that the image selected in accordance with the detected error condition is output on the display unit. There is also disclosed a corresponding method for warning a vehicle driver of a rail vehicle and the use of a warning system of a rail vehicle for displaying an actual condition of a rail vehicle.

In rail vehicles, such as railways, trams, etc. for example, diagnostic information that outputs or indicates an actual condition of the rail vehicle is usually displayed on electronic display devices. The actual condition can, depending on the condition of the rail vehicle, describe a normal condition in which the rail vehicle has no functional limitations, and no further action is required for a vehicle driver. However, under certain conditions, the actual condition can also describe a corresponding error condition of the rail vehicle, such as exceeding temperature limits for example. In order to correct this error condition, a corresponding need for action on the part of the vehicle driver may be necessary. For example, in the event of a defect in drive motors, it may be necessary to deactivate them in order to be able to continue operating the vehicle. The display devices on which the diagnostic information is displayed are usually located in a driver's cab of the rail vehicle so that the diagnostic information can be viewed by a vehicle driver. The diagnostic information is usually displayed as text on the display device. The registration of the text by the vehicle driver can take some time depending on the length of the text. During this period, the vehicle driver may not be able to fully concentrate on traffic. In addition, the vehicle driver needs a deeper understanding of the vehicle in order to recognize, by means of the diagnostic information displayed in text format, which operational restriction exists and whether a need for action or what need for action is necessary. In practice, this often leads to uncertainty for the vehicle driver. These uncertainties can in turn lead to over-cautious actions of the vehicle driver, which, for example, disrupt operation (train is stopped, although only simple operational actions are necessary to reconfigure the vehicle, e.g., a zero-position acknowledgement of the drive lever, i.e., a neutral position of the drive lever) and possibly entail correspondingly high subsequent costs. Such high subsequent costs can arise, for example, in the event of unnecessary accommodation of the rail vehicle in maintenance depots, wherein the inspection of the rail vehicles determines that there is no damage.

In order to solve these problems, an attempt has been made to divide the diagnostic information of the rail vehicle into categories according to the severity of the existing faults. The categorization is often carried out in the form of letters “A”, “B”, “C”, etc., which can be displayed to a vehicle driver, and are intended to describe a certain degree of severity of a pre-existing fault. Despite extensive training, it can often be difficult to evaluate the individual severity categories. In addition, categorizing the diagnostic information or faults does not necessarily indicate whether there is a need for action and, if so, what action is required for a vehicle driver.

If, as described above, letters are used to categorize the severity, this may additionally lead to uncertainty and confusion on the part of the vehicle driver, since the assignment between letters and a severity level is not clear and self-explanatory.

It is an object of the present invention to output diagnostic information or an actual condition of a rail vehicle in such a way that these take into account the physical conditions of perception and mental receptiveness of a vehicle driver.

This task is achieved by means of a warning device as claimed in claim 1, by means of a rail vehicle as claimed in claim 11, a warning system as claimed in claim 12, the use of the warning device as claimed in claim 13 and by means of a method as claimed in claim 14.

The warning device according to the invention for a rail vehicle comprises at least the following components:

A component is an error detection apparatus that is designed to detect at least one error condition of the rail vehicle. The error detection apparatus can also only be an interface, as is explained in more detail later, which detects or passes a detected error condition. For example, an error condition of the entire rail vehicle can be detected. However, a plurality of error conditions with different components of the rail vehicle can also be detected. Error conditions can describe, for example, a drive failure, exceeding temperature thresholds, incorrect input of operating data or the like.

Another component of a warning device according to the invention is an image memory that contains a number of images. The images indicate an actual condition of a rail vehicle or its components. As explained above, the actual condition can describe a normal condition or an error condition of the rail vehicle.

The images are preferably designed in such a way that they are self-explanatory and intuitively show a vehicle driver a corresponding need for action. For this purpose, the images are preferably presented in such a way that they take into account the physical conditions of human perception and the reception of information, thereby being aimed at improving and expediently organizing the vehicle driver's perception of the displayed information in a certain way. In particular, the images do not therefore contain any written-out text. However, they can optionally contain individual letters with a generally comprehensible informational content.

In addition, the warning device comprises a first selection unit for selecting at least one of the images from the image memory depending on a detected error condition of the rail vehicle. Preferably, the selection unit can comprise an integrated circuit, particular preference being given to an ASIC. Preferably, the selection unit can also comprise a microcontroller or another universal computing unit.

In order to indicate the actual condition of the rail vehicle to the vehicle driver by means of the image selected by the selection unit, the warning device comprises at least one user interface with at least one display unit. The user interface can be, for example, a monitor in the driver's cab of the rail vehicle. The display unit can be, for example, a display or a driver's cab display of the monitor for the visualization of the image selected by the selection unit and, for example, be designed as a touch screen.

Another component of the warning device is a display control unit in order to control the display unit in such a way that the image selected depending on the detected error condition is output on the display unit to warn the vehicle driver. The display control unit preferably comprises a universal computing unit and a graphics interface, which can also be integrated within the universal computing unit.

In the case of a corresponding method according to the invention for warning a vehicle driver of a rail vehicle, initially, at least one error condition of the rail vehicle is detected by means of an error detection apparatus.

After the error condition has been detected, at least one image contained in an image memory is selected by means of a selection unit depending on this error condition.

In order to display the selected image to the vehicle driver, a display unit of at least one user interface of the warning device is controlled by means of a display control unit. This allows the image selected depending on the detected error condition to be output on the display unit in order to warn the vehicle driver in this way.

The inventive use of a warning device, in particular, the warning device according to the invention, allows an actual condition of a rail vehicle to be indicated in order to warn a vehicle driver.

The warning device or components of the warning device can be arranged or installed in any rail vehicle when manufacturing said vehicle.

The warning device according to the invention can however also be installed, for example, in a driver's cab of an already existing rail vehicle in order to retrofit this in this manner.

For example, by using a small number of easy-to-understand images to display or represent an actual condition, a quick and easy comprehensibility of the required need for action in the event of an error condition is achieved. This requires only a relatively low level of vehicle know-how of the vehicle driver. Thus, no additional training is also required to explain the evaluation of the error condition to the vehicle personnel. In turn, this can significantly reduce vehicle-driver training costs.

For the rail vehicle operator, the warning device according to the invention can also avoid costs that have previously arisen due to misconduct of a vehicle driver if the latter cannot interpret the error conditions of the rail vehicle.

A further advantage arises, for example, for the manufacturers of a rail vehicle, since false reports and possibly non-applicable claims for damages can be minimized by means of a warning device.

In order to be able to receive error condition signals also on the landside (i.e., outside the rail vehicle, for example in a service center), the warning system mentioned above comprises at least a second radio system, which is located on the landside of a rail vehicle and communicates with a first radio system of a warning device according to the invention, as will be explained later on in more detail.

Using the warning system, the images that show a corresponding error condition of a rail vehicle can then also be displayed to workshop staff, for example, in service and diagnostic tools.

For example, in order to be able to statistically evaluate the error conditions of the rail vehicle, for example, in the service center, the warning system preferably comprises an evaluation device, which is preferably located on the landside with respect to the rail vehicle. This preferably communicates with the second radio system for the evaluation of the determined error signal states or error conditions of the rail vehicle. Here too, the corresponding images can be displayed, so that, for example, the evaluation by personnel can be carried out more quickly. This also applies in particular to personnel who do not have a deep background knowledge of the technical processes of the rail vehicle. For example, an increase in efficiency in the tracking of error conditions or error signals can also be expected by means of an evaluation device.

Most of the above-mentioned components of the warning device can be implemented in whole or partially in the form of software modules in a processor of a corresponding control device. A largely software-based implementation has the advantage that even previously used control devices can also be easily expanded by means of a software update in order to work in the manner according to the invention. In this respect, the task is also achieved by means of a corresponding computer program product with a computer program, which can be loaded directly into a memory device of a control device of a warning device with program sections to perform all steps of the method according to the invention when the program is executed in the control device. In addition to the computer program, such a computer program product can comprise additional components if required, such as documentation and/or additional components as well as hardware components, such as hardware keys (dongles etc.) for the use of the software for example.

For transport to the control device and/or for saving on or in the control device, a computer-readable medium can be used, for example, a memory stick, a hard drive or another transportable or permanently installed data carrier, on which the program sections of the computer program are stored, which can be read and executed by a computer unit of the control device. The computer unit can have, for example, one or a plurality of interacting microprocessors or the like.

Other especially favorable embodiments and further embodiments of the invention result from the dependent claims as well as the following description, wherein the claims of a certain claim category can also be further developed into another claim category analogously to the claims and description parts and, in particular, individual features of different exemplary embodiments and variants can also be combined into new exemplary embodiments and variants.

For the detection of at least one error signal, at least one component of the rail vehicle, such as the locomotive, individual railcars, the traction vehicle or the like for example, the error detection apparatus preferably comprises at least one error detection interface.

Particularly preferably, the error detection apparatus also comprises an evaluation unit, which is designed for determining an error condition of the rail vehicle on the basis of the detected error signal or a plurality of detected error signals. However, the evaluation unit is only optional and is not needed if, for example, the error signal already corresponds to an error condition. If, for example, the error signal is an error code, the error condition is already signaled directly by means of this code. An evaluation unit would therefore not be necessary here.

In order to enable the images to intuitively show a vehicle driver a corresponding need for action as quickly and easily as possible, the images are preferably designed as image symbols, particularly preferably, as pictograms and/or icons. This means, for example, that the color, the brightness and the contrast, etc. of the images are adapted to the perception of the vehicle driver. By designing the images or pictograms correspondingly, an actual condition of a rail vehicle can be conveyed very easily and in a manner independent of language, cultural background and technical know-how.

For example, a lowercase blue letter “i” indicates to the vehicle driver that there are no operational restrictions. In this case, that means the actual condition of the rail vehicle corresponds to the normal condition. In the following, further examples of images or pictograms are shown, which give the vehicle driver information about the actual condition of the rail vehicle and, if necessary, indicate a corresponding need for action:
A lowercase red x in a circle and a green human hand with an out-stretched thumb and index finger and with the index finger pointing toward the red x→An operating error is present, or an operational action is necessary.
A locomotive with a superimposed yellow warning triangle with an exclamation mark arranged therein→An operational restriction exists, but further travel is possible.
A locomotive with a superimposed yellow spanner→A operating restriction exists, a prompt stop at a workshop is necessary.
A locomotive with a superimposed red stop sign and/or an exclamation point→No further travel possible, the rail vehicle should be brought to a safe stop immediately.

The above-described images or pictograms and their explanation, for example, are preferably also shown in vehicle documentation, e.g., in the manuals of the rail vehicle type. This allows a vehicle driver to quickly and easily look up or read an explanation of a picture if necessary.

However, the images for individual error conditions can in principle also be displayed individually. Preferably, however, an entire actual condition of a rail vehicle, is displayed on a central point of the display unit or the driver's cab display, which can correspond to a summary of the error conditions of the rail vehicle for example, as has already been mentioned.

For example, in order to obtain additional information on the actual condition of a rail vehicle if necessary, the warning device preferably comprises an error text memory, which comprises a number of error information texts on different error conditions of the rail vehicle. These error information texts describe in short, concise, simple language the actual condition of the rail vehicle as well as the possible need for action.

In addition, the warning device preferably comprises a second selection unit for selecting at least one of the error information texts of the error text memory depending on the detected error condition of the rail vehicle. However, the second selection unit for selecting the error texts can also be designed separately from the first selection unit. The second selection unit can correspond to the first selection unit, which serves to select one of the images from the image memory depending on a detected error condition of the rail vehicle, therefore the term “evaluation unit” is used in summary for both in the following.

The error texts could correspond, for example, to the above-described explanations for the already described pictograms. An error text could read: “An operating error is present, or an operating action is necessary” if, for example, the error condition of a traction lock is present, and the pictogram of a green human hand is displayed.

The display control unit of the warning device is preferably designed in such a way that, for to warn a vehicle driver, the error information text selected depending on an error condition is output on the display unit.

To output an error information text as needed, the user interface preferably comprises an input unit to detect a text display command. The input unit is particularly preferably integrated in the display unit of the warning device and may be designed, for example, as a touchscreen.

Preferably, when detecting an error condition, the image selected depending on the error condition is initially output on the display unit. Only when the text input command is detected, which was triggered or transmitted by a previous actuation of the input unit by the vehicle driver, is the error information text selected depending on the error condition output on the display unit.

Preferably, the error information text can be output next to the image on the display unit.

For example, if the display unit is relatively small, the error information text can also be preferably output instead of the image.

For a better overview, the actual conditions of a rail vehicle can be displayed by means of the corresponding images and, if necessary, the error information texts can also be displayed in a tabular form on a display unit.

Preferably, an area or a display area in which the image is displayed on the display unit comprises a sensor region. In this case, the sensor region is preferably designed as part of the input unit for entering the text display command. For example, the vehicle driver can actuate the input unit by tapping the sensor region. However, the input unit could, for example, also be triggered capacitively, for example, by the vehicle driver holding their hand only at a certain distance over the sensor region.

The display unit of the warning device can also be made, for example, of multiple parts, and display the images corresponding to the error conditions on one side and display the corresponding error information texts on another side, for example. However, the user interface could also comprise a second display unit, wherein the display control unit of the warning device is designed to control the second display unit in such a way that, for warning a vehicle driver, the error information text selected depending on the error condition is output on the second display unit. For example, this could simultaneously display an image on the first display unit and a corresponding error information text on the second display unit of the user interface.

Often, it is favorable to inform persons who are not in the rail vehicle, such as a central train conductor or workshop personnel for example, about the actual condition of the rail vehicle. For this purpose, the warning device preferably has the previously mentioned first radio system for converting the error condition into at least one error condition signal and transmitting this signal, which is preferably integrated in a rail vehicle. The error condition signal is preferably determined by the error condition detected and transmitted by the error detection apparatus. The radio system preferably has a signal evaluation unit. The error condition signal can then be transmitted, for example, to the second radio system of the warning system, which is located on the landside of the rail vehicle.

The above-mentioned steps for detecting the error condition up to the output of the images and, if applicable, the error information texts on a display unit preferably take place on the software side.

A layer architecture is preferably used for the computer program of the warning device. The use of three-layer architecture is particularly preferred. This means that the architecture consists of three layers on the software side. However, these three layers are preferably described by a graphic layer, a logic layer and a data layer.

The graphics layer preferably comprises the user interface as well as the display unit.

The logic layer preferably comprises the selection unit for selecting at least one of the images from the image memory as well as the selection unit for selecting at least one of the error information texts from the error text memory. In addition, the logic layer preferably comprises the display control unit in order to control the display unit in this way. As a result, the image selected depending on the detected error condition and the error information text selected depending on the detected error condition are output on the display unit to warn a vehicle driver.

The data layer preferably comprises the error detection apparatus, the symbol memory and, if necessary, the error text memory.

The three layers preferably build up from bottom to top, one on top of the other, wherein the lowest layer preferably corresponds to the data layer, the middle layer corresponds to the logic layer and the top layer corresponds to the presentation layer. This arrangement can avoid unwanted dependencies in one direction.

The invention is explained in more detail once again below with reference to the enclosed figures on the basis of exemplary embodiments. Thereby, identical components in the various figures are provided with identical reference numbers. The figures are generally not to scale. In the figures:

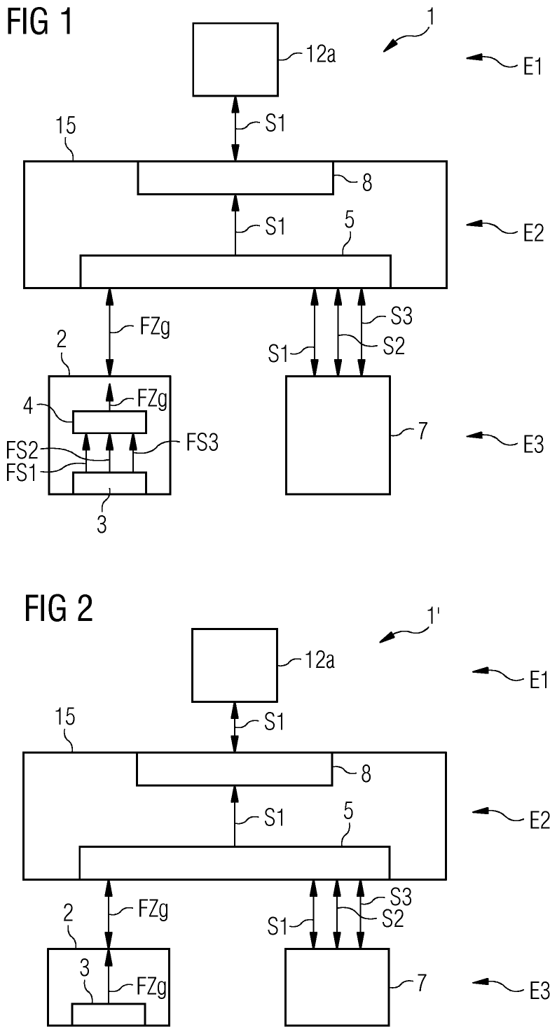

FIG. 1 shows a block diagram of a warning device according to the invention in accordance with a first exemplary embodiment in a rough schematic view,

FIG. 2 shows a block diagram of a warning device according to the invention in accordance with a second exemplary embodiment in a rough schematic view,

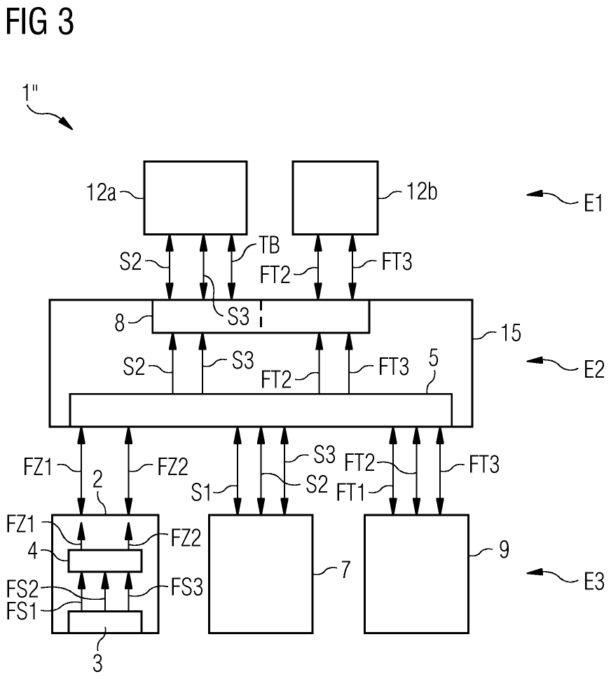

FIG. 3 shows a block diagram of a warning device according to the invention of a according to the invention in accordance with a third exemplary embodiment in a rough schematic view,

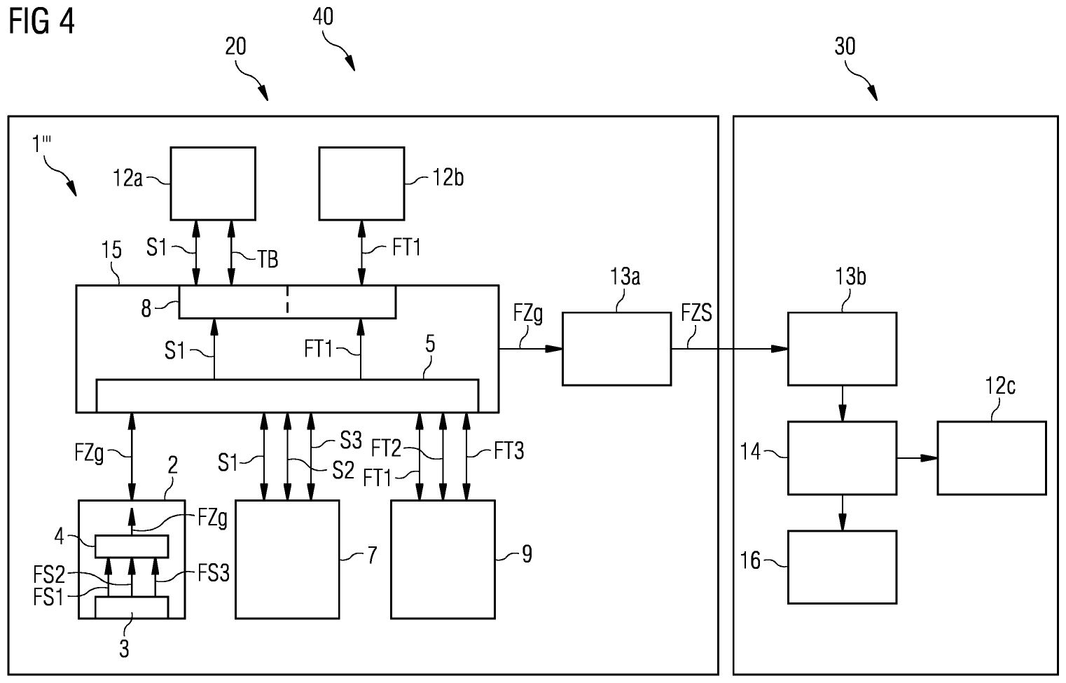

FIG. 4 shows a block diagram of an exemplary embodiment of a warning system according to the invention, which contains a warning device in accordance with a fourth exemplary embodiment in a rough schematic view,

FIG. 5 shows a monitor of a warning device according to the invention, on which a first image corresponding to an actual condition of a rail vehicle is displayed in a schematic view,

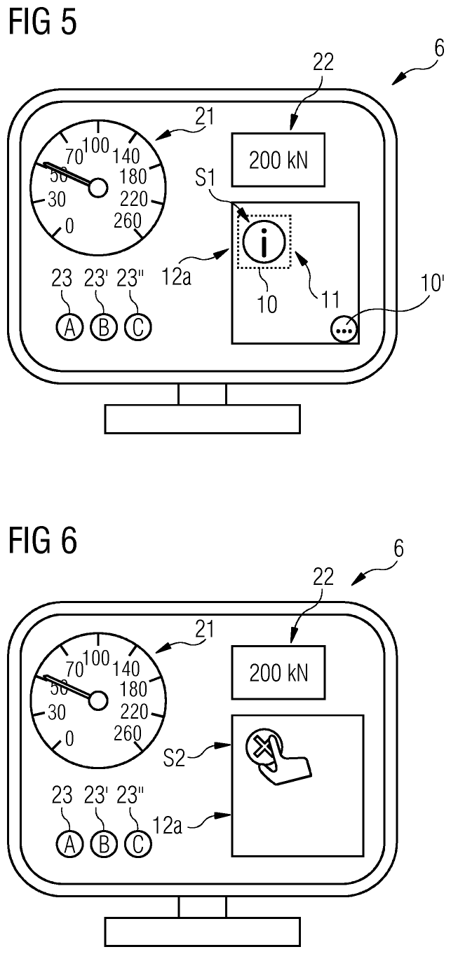

FIG. 6 shows the monitor from FIG. 5, on which a second image is displayed corresponding to an actual condition of the rail vehicle in a schematic view,

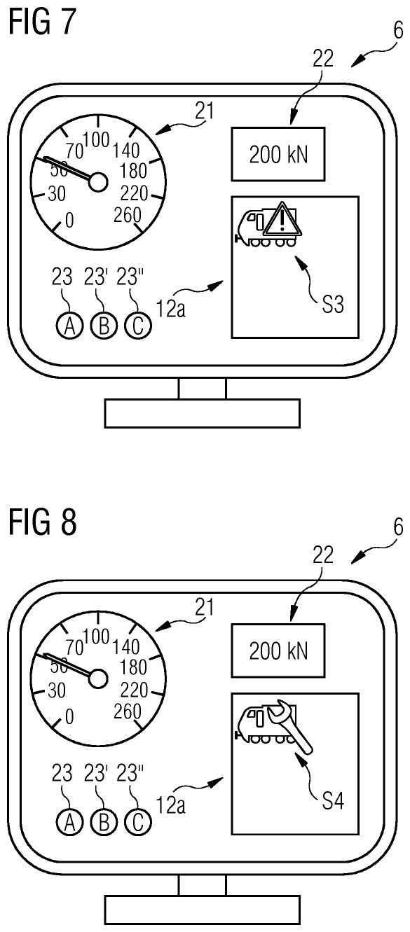

FIG. 7 shows the monitor from FIG. 5, on which a third image is displayed corresponding to an actual condition of the rail vehicle in a schematic view,

FIG. 8 shows the monitor from FIG. 5, on which a fourth image is displayed corresponding to an actual condition of the rail vehicle in a schematic view,

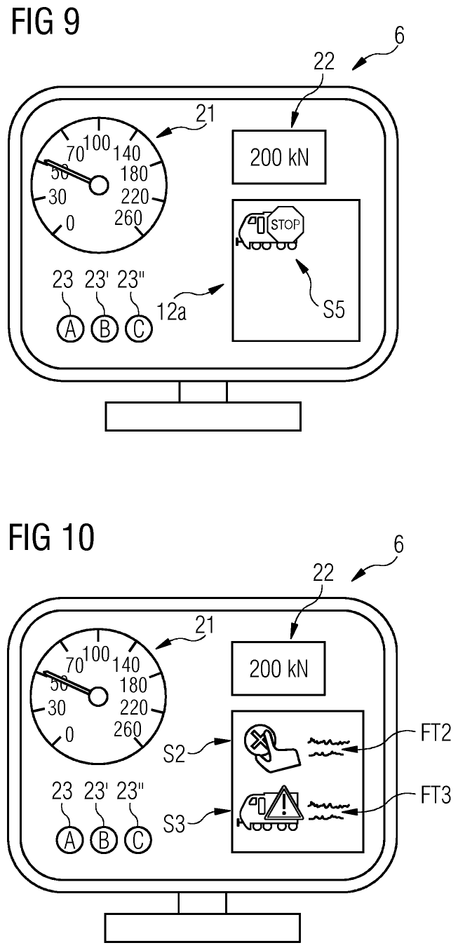

FIG. 9 shows the monitor from FIG. 5, on which a fifth image is displayed corresponding to an actual condition of the rail vehicle in a schematic view, and

FIG. 10 shows the monitor from FIG. 5, on which the second image from FIG. 6 and the third image from FIG. 7, as well as error information texts are displayed corresponding to error conditions of the rail vehicle, in a schematic view.

In FIG. 1, the system architecture of an exemplary embodiment of a warning device 1 is shown schematically in a block diagram. The system architecture here is roughly divided into three levels. In the lowest level E3 there is an error detection apparatus 2, which here detects an error condition FZg of a rail vehicle 20 (see FIG. 4). The error detection apparatus 2 comprises here an error detection interface 3 to detect error signals FS1, FS2, FS3 of components of a rail vehicle 20. The detected error signals FS1, FS2, FS3 are transmitted to an evaluation unit 4 of the error detection apparatus 2. From the transmitted error signals FS1, FS2, FS3, the evaluation unit 4 determines here an error condition FZg or an overall error condition FZg of the rail vehicle 20. The overall error condition FZg determined here is transmitted to the second level E2, here a control device 15.

In the lowest level E3 of the system architecture of the display device 1 there is also an image memory 7, which contains a number of images S1, S2, S3, which describe a corresponding error condition. These images S1, S2, S3 are also transmitted to the control device 15.

By means of a selection unit 5 of the control device 15, a corresponding image S1 is then transmitted on the basis of the error condition FZg transmitted by the error detection apparatus 2 to a display control unit 8 of the control device 15. The display control unit 8 can then control a display unit 12a, which is located in a first level E1 of the system architecture of the warning device 1, so that the image S1 transmitted to the display control unit 8 is represented on the display unit 12a. The display unit 12a can be, as explained later in more detail, for example a driver's cab display or a zone of a driver's cab display in a rail vehicle 20. On this, an actual condition of the rail vehicle 20 can then be displayed to a vehicle driver by means of the transmitted image S1 from the image memory 7.

In FIG. 2, a block diagram of the system architecture of a second exemplary embodiment of a warning device 1′ is shown. Here, however, the error detection apparatus 2 does not have an evaluation unit 4, but only an error detection interface 3. An evaluation unit 4 is not necessary here, because the error signal directly already indicates an error condition and does not have to be analyzed or converted first. In FIG. 2, for example, the error signal is an error code and thus signals the error condition FZg directly. The further structure of the warning device 1′ according to the invention corresponds to that of FIG. 1.

With the warning device according to the invention, however, not only an error condition FZg or an overall error condition FZg of a rail vehicle 20 can be output and displayed, as this is described in FIGS. 1 and 2. A plurality of error conditions FZ1, FZ2 can also be detected and displayed. These error conditions FZ1, FZ2 can, for example, describe error conditions of individual components of the rail vehicle 20. FIG. 3 schematically shows this in a third exemplary embodiment of a warning device 1″ according to the invention. By means of the evaluation unit 4 of the error detection apparatus 2, here, an error condition FZ1 of a first component and a second error condition FZ2 of a second component of the rail vehicle 20 are detected and transmitted to a selection unit 5. The selection unit 5 then selects an image S2 to match the first error condition FZ1 and selects an image S3 to match the second error condition FZ2 from the image memory 7, thereby displaying it on the display unit 12a.

If, in addition to the pictures S1, S2, S3, further information on the actual condition of the rail vehicle 20 is to be displayed to the vehicle driver, for example, the warning device 1″, as shown in FIG. 3, can comprise an error text memory 9. This error text memory 9 is located in the lower level E3 with the error detection apparatus 2 and the image memory 7. The error text memory 9 comprises various error information texts FT1, FT2, FT3. Each of the error information texts FT1, FT2, FT3 can also be assigned to an error condition FZ1, FZ2. In the selection unit 5, a first error information text FT2 and a second error information text FT3 are then transmitted to the display control unit 8 according to the received error conditions FZ1, FZ2. Again, for example, only an error information text FT1 could be transmitted here if an overall error condition FZg is to be described.

For displaying the error information texts FT2, FT3, the display device 1″ here comprises a second display unit 12b. The second display unit 12b is controlled by the display control unit 8 in such a way that the corresponding error information texts FT2, FT3 can be displayed on the display unit 12b. However, they could also be displayed on the display unit 12a.

The display control unit 8 can correspond to the display control unit 8, which controls the display unit 12a in such a way that the images S2, S3 selected depending on the detected error condition FZ1, FZ2 can be displayed on the display unit 12a. The display control unit 8 can also be separate from the first display control unit 8.

The corresponding error information texts FT2, FT3 are displayed here only after entering or receiving a text display command TB by a vehicle driver on the second display unit 12b. For example, by pressing an input unit 10, which will be explained in more detail later.

To display the actual conditions of a rail vehicle 20 and also outside a rail vehicle 20, for example, in a service center, the exemplary embodiment shown in FIG. 4 of a warning system 40 according to the invention comprises components that are located in the rail vehicle 20 and components that are located on a landside 30. The components of the warning system 40, which are arranged in the rail vehicle, are comprised here by a fourth exemplary embodiment of a warning device 1′″. In order to display the error condition FZg on a landside 30, the warning device 1′″ comprises a first radio system 13a, which detects an error condition FZg transmitted by the control device 15. The first radio system 13a then, due to the received error condition FZg, passes a resulting error condition signal FZS to a second radio system 13b, which is located on the landside, for example, in the service center. The second radio system 13b passes the error condition signal FZS to an evaluation device 14. In the evaluation device 14, the error conditions of the rail vehicle can then be evaluated statistically for example. The evaluation unit 14 is again electronically connected to a display unit 12c, in which a picture S1 corresponding to the error condition FZg and if necessary, also a corresponding error information text FT1 can be displayed. In an error memory 16 electronically connected with the evaluation device 14, the previously determined error conditions FZg and, for example, additional information collected about the error conditions FZg can then be stored, such as vehicle type, date and time of occurrence of the error condition, etc. The remaining structure of the warning device 1′″ according to the invention corresponds to that of FIG. 3.

If instead of an overall error condition FZg, as shown in FIG. 4, a plurality of error conditions FZ1, FZ2 are transmitted, then of course the radio system 13a can also emit a corresponding number of error condition signals FZS.

FIG. 5 shows an example of a user interface 6, here a monitor 6, an exemplary embodiment of a warning device according to the invention. The monitor 6 is located in a driver's cab of a rail vehicle 20 for example. On the monitor 6 or on the driver's cab display, on the one hand, a speedometer 21 is displayed, on which the current speed in km/h of the rail vehicle 20 can be read. On the other hand, an indicator 22 is shown, which shows the pulling force corresponding to the speed in N/m. In addition, various menu items 23, 23′, 23″ can be seen on the monitor 6, under which the vehicle driver can make further entries or retrieve further information about the course of the journey for example.

In accordance with an overall error condition FZg of the rail vehicle 20 detected by the warning device 1, 1′, 1″, 1′″ according to the invention, an image S1, here a symbol S1 or a pictogram S1, is shown in the display unit 12a in FIG. 5. The pictogram S1 here is a small “i”, preferably in blue, by means of which it is communicated to the vehicle driver that there is no operational restriction.

FIGS. 6 to 10 show the same monitor 6 or the same driver's cab display from FIG. 5, but with different pictograms, which are displayed on the display unit 12a.

The pictogram S2 on the display unit 12a in FIG. 6, shows a lowercase x in a circle, preferably colored red and a hand above it, preferably shown in green, thereby extending its thumb and index finger. This pictogram S2 indicates to the vehicle driver that there is an operating error, or that an operating action is necessary.

In FIG. 7, a pictogram S3 is shown in the display unit 12a that contains a locomotive, preferably colored black, with a superimposed warning triangle, preferably shown in yellow. An exclamation point, preferably shown in black, is arranged in the warning triangle. If this pictogram S3 appears on the driver's cab display, this indicates that there is an operational restriction of the rail vehicle, but further travel is possible.

In FIG. 8 another pictogram with a locomotive, preferably in black, with a superimposed spanner, preferably in yellow, is shown. This pictogram S4 indicates to the vehicle driver that there is an operational restriction and that a prompt stop at a workshop is necessary.

The pictogram S5 in FIG. 9 shows a locomotive, preferably shown in black, with a superimposed stop sign, preferably in red. This means that it is not possible for the rail vehicle 20 to travel further and that the rail vehicle 20 should be brought to a safe stop immediately.

In FIGS. 5 to 9 a total error condition FZg of the rail vehicle 20 was displayed in each case in the driver's cab display 6. As already explained, a plurality of error conditions FZ1, FZ2 can also be displayed by means of different images or pictograms. FIG. 10 shows a first pictogram S2 and a second pictogram S3 on a monitor 6 in the display area 12a. In the same display area 12a, corresponding error information texts FT2, FT3 are displayed next to the pictograms S2, S3.

The error information texts FT2, FT3 can be displayed next to the pictograms S2, S3, as shown in FIG. 10. However, they can also be displayed instead of the pictograms. For this purpose, the display device 12a has an input unit 10, 10′. The input unit 10 may correspond to a sensor region 11 in a preferred variant of the warning device according to the invention, as shown in FIG. 5. The sensor region 11 comprises an area on which the first symbol S1 is displayed on the display unit 12a. For example, if a vehicle driver taps the symbol S1, the input unit 10 is actuated and a text display command TB is emitted and instead of the symbols or also next to the symbols an error information text is displayed (not shown in FIG. 1). The input unit 10′ does not have to correspond to a sensor region 11, but can also correspond, for example, to a kind of button, which is also arranged on the vehicle driver's cab display for example.

In conclusion, it is again pointed out that the devices, applications and methods described above in detail, are merely exemplary embodiments, which can be modified by the person skilled in the art in various ways without leaving the realm of the invention. For example, a warning device can only display an overall error condition or also a plurality of error conditions using images and, if necessary, also with error information texts. Still, the use of the indefinite article “a” or “an” does not rule out that a plurality of the features in question can also be available. Similarly, the term “unit” does not exclude the possibility that the components in question consist of a plurality of interacting sub-components, which may optionally also be spatially distributed.

1-16. (canceled)

17. A warning device for a rail vehicle, the warning device comprising:
an error detection apparatus configured to detect at least one error condition of the rail vehicle;
an image memory containing a plurality of images indicating an actual condition of a rail vehicle, the images being designed as image symbols;
a first selection unit for selecting at least one of the images from the image memory depending on a detected error condition of the rail vehicle;
a user interface with a display unit, said user interface having an input unit for detecting a text display command;
a display control unit for controlling said display unit and to output a warning to a vehicle driver by selecting and displaying the image selected by the first selection unit in dependence on the detected error condition;
an error text memory containing a plurality of error information texts for different error conditions of the rail vehicle;
a second selection unit for selecting at least one of the error information texts from the error text memory depending on the detected error condition of the rail vehicle;
said display control unit being configured to warn the vehicle driver by outputting on the display unit the error information text selected in dependence on the detected error condition; and
wherein, when an error condition of the rail vehicle is detected, the image selected depending on the error condition is output first on the display unit, and only after a text display command is detected, the error information text selected in dependence on the error condition is output on the display unit.

18. The warning device according to claim 17, wherein the input unit for detecting the text display command is integrated within the display unit.

19. The warning device according to claim 17, wherein said error detection apparatus comprises at least one error detection interface for detecting at least one error signal of at least one component of the rail vehicle.

20. The warning device according to claim 19, wherein said error detection apparatus further comprises an evaluation unit configured to determine an error condition of the rail vehicle based on the detected error signal or a plurality of detected error signals.

21. The warning device according to claim 17, wherein the image symbols are pictograms and/or icons.

22. The warning device according to claim 17, wherein said display control unit is configured to output the selected error information text on said display unit next to the image.

23. The warning device according to claim 17, wherein said display control unit is configured to output the selected error information text on said display unit instead of the image.

24. The warning device according to claim 17, wherein an area in which the image is displayed on said display unit comprises a sensor region that forms part of said input unit for entering the text display command.

25. The warning device according to claim 17, comprising radio system for transmitting at least one error condition signal.

26. A rail vehicle, comprising a warning device according to claim 17.

27. A warning system for rail vehicles, the warning system comprising:
a warning device according to claim 17 mounted on a rail vehicle, said warning device comprising a vehicle-side radio system for transmitting at least one error condition signal; and
a track-side radio system configured for communicating with the vehicle-side radio system and for a track-side reception of the at least one error condition signal output by said vehicle-side radio system.
